(19) United States
(12) Patent Application Publication
(10) Pub. No.: US 2016/0301594 A1
(43) Pub. Date: Oct. 13, 2016

(54) INTER-CHASSIS PEER AND METHOD USED THEREIN

(71) Applicant: TELEFONAKTIEBOLAGET L M ERICSSON (PUBL), Stockholm (SE)

(72) Inventors: Jiang He, Beijing (CN); Baifeng Cui, Beijing (CN); Ying Lu, Beijing (CN)

(21) Appl. No.: 15/038,556

(22) PCT Filed: Dec. 6, 2013
(86) PCT No.: PCT/CN2013/088793

§ 371 Date: May 23, 2016

(51) Int. Cl. H04L 12/751; H04L 12/775; H04L 12/721

(52) U.S. Cl. CPC H04L 45/02; H04L 45/12; H04L 45/58

(57) ABSTRACT

The disclosure relates to a method of Link State ID planning in an inter-chassis device comprising a plurality of peers. In one embodiment, the method comprises steps of generating an LSA and transmitting the generated LSP outside at a peer. The Link State ID in the generated LSA is selected from a number range assigned to that peer. The number ranges assigned to different peers of the inter-chassis device do not overlap with each other. By the Link State ID planning method, the peer may discover automatically other peers in the same inter-chassis device.

### TECHNICAL FIELD

The disclosure relates to a peer in an inter-chassis device. In particular, some embodiments of the disclosure relates to a Link State ID planning for peers in an inter-chassis device.

### BACKGROUND

Unless otherwise indicated herein, the approaches described in this section are not prior art to the claims in this disclosure and are not admitted to be prior art by inclusion in this section.

Internet Protocol version 6 (IPv6) has already been widely used especially in the core network. Open Shortest Path First version 3 (OSPFv3), as a companion of IPv6 to build routing information for the network, is more and more popular in the world.

There are many circumstances of node failure happening, which causes mission-critical applications down, such as unexpected power outage, earthquake and etc. And usually, it will take much time to restore the failed node, especially when the node is in the faraway place like desert. As a result, node level protection is a mechanism to counterwork this kind of scenarios.

Network high-availability can be achieved by employing intra and inter-chassis redundancy mechanisms. Unlike intra-chassis redundancy, inter-chassis redundancy can provide node level redundancy for mission-critical applications that require tight Service Level Agreements (SLAs). It is the intension of inter-chassis redundancy.

FIG. 1 shows the physical and logical view of an inter-chassis device in the prior art. As shown, an inter-chassis device appears to be a logical device but actually consists of several physical devices to form a redundancy group. The purpose is to provide node level redundancy. All the devices in the inter-chassis device are configured as peers to others. Peers in the inter-chassis device could be directly connected or indirectly connected.

The inter-chassis redundancy mechanism can be employed on either the attachment circuit or pseudowire front, to provide inter-chassis redundancy for Link Aggregation Control Protocol (LACP) or pseudowire.

When deployed under OSPFv3 environment, the inter-chassis router appears as one router in the topology, each having its own control plane and being synchronous to other peers.

FIG. 2 shows a typical inter-chassis device in a network. Referring to FIG. 2, the left portion illustrates the physical view of an inter-chassis device, while the right portion illustrates the logical view of the inter-chassis device. As shown in FIG. 2, both peer A and peer B are connected physically to Node D. In logic, the two peers act as one router, i.e., Router AB, to Node D, as shown in right side of FIG. 2.

Router AB, consisted by peer A and B, is regarded as one router by Router C. Router AB could provide inter-chassis applications such as Pseudowire Redundancy Application, LACP.

Pseudowire redundancy is established between Router C<->Router AB. Actually the pseudowire is attached to peers A and B of Router AB. Dual access is also established from node D to both router A and B. Actually the access circuit is attached to peers A and B of Router AB. Thus traffic between Node D and router C are protected by inter-chassis redundancy on Router AB.

There is no automatic discovery mechanism for peers in the inter-chassis device under OSPFv3 environment. Currently, the peer address is manually configured, which burdens the administrator of the device.

### SUMMARY

An object of the disclosure is to provide a method used at a peer in an inter-chassis device, by which such peer is possible to differentiate LSAs generated by itself from LSAs generated by other peers in the same inter-chassis device, then possible to automatically discover other peers in the inter-chassis device, and thus there is no need to manual operations on peers' addresses.

According to a first aspect, there is provided a method used in a peer in an inter-chassis device which comprises a plurality of peers. The peer generates a Link State Advertisement (LSA). The generated LSA has a Link State ID which is selected from a Link State ID number range assigned to the peer. The peer then transmits the generated LSA. The Link State ID number ranges assigned to different peers in the inter-chassis device do not overlap with each other. So, LSAs generated by respective peers in the same inter-chassis device can identify themselves by the Link State IDs included therein, and thus do not conflict with each other.

In one embodiment, the peer receives an LSA, and determines whether the received LSA is transmitted from the peer by comparing the Link State ID in the received LSA with the Link State ID number range assigned to the peer if Router ID field in the received LSA indicates that it comes from the same inter-chassis device as the peer. If the Link State ID falls outside the Link State ID number range assigned to the peer, the peer may learn that the received LSA comes from another peer in the inter-chassi device. Otherwise, it is determined that the received LSA is locally generated. Thus, a peer may automatically discover other peers by looking into the Link State ID included in the LSA and the Link State ID number planning in the inter-chassis device.

For network LSAs and Link LSAs, the Link State ID is equal to the interface ID on the link they are transmitted over. In one embodiment, the peer is assigned with an interface number range, and the interface number ranges assigned to different peers of the plurality of peers do not overlap with each other. The peer then selects a number in the interface number range assigned thereto as an interface ID of an interface of the peer.

In one embodiment, the peer may receive an LSA, and determine type of the received LSA based on LS type field in the received LSA if Router ID field in the received LSA indicates that it comes from the same inter-chassis device as the peer. If it is determined that the type of the received LSA is network LSA or link LSA, the peer determines whether the received LSA is transmitted from the peer by comparing the Link State ID of the received LSA with the interface number range assigned to the peer since the Link State ID of a network LSA or a link LSA is equal to the interface ID. If it is determined that the type of the received LSA is neither network LSA nor link LSA, the peer determined whether the received LSA is transmitted from the peer by comparing the Link State ID of the received LSA with the Link State ID number range assigned to the peer. By using the LS type field in discovering source of a received LSA, the number of peers that can be configured in an inter-chassis device is increased because the interface number range assigned to one peer is allowed to overlap with the Link State ID number range assigned to another peer.

In one embodiment, the inter-chassis device is a router operable under Open Shortest Path First (OSPF) for Internet Protocol version 6 (IPv6).

According to a second aspect, there is provided peer in an inter-chassis device comprising a plurality of peers. The peer comprises a generator which is configured to generate a Link State Advertisement (LSA) and a transceiver which is configured to transmit the generated LSA. The generated LSA has a Link State ID that is selected from a Link State ID number range assigned to the peer. The Link State ID number ranges assigned to different peers in the same inter-chassis device do not overlap with each other.

According to a third aspect, there is provided a peer in an inter-chassis device which comprises a plurality of peers. The peer comprises a communication interface arranged for communication, a processor and a memory storing computer program code thereon. The program, when run in the processor, causes the peer to select a number in a Link State ID number range assigned thereto, and generate an LSA by using the selected number as the Link State ID. The Link State ID number ranges assigned to different peers in the inter-chassis device do not overlap with each other.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 shows the physical and logic view of an inter-chassis device in the prior art.

FIG. 2 illustrates a typical inter-chassis device in a network.

FIG. 3 illustrates a flowchart of an inter-chassis device configuration method in the prior art.

FIG. 4 illustrates a flowchart of a method according to an embodiment of the disclosure.

FIG. 5 illustrates an exemplary result according to the method shown in FIG. 4.

FIG. 6 illustrates a flowchart of a peer discovery method according to an embodiment of the disclosure.

FIG. 7 illustrates an exemplary result according to the method shown in FIG. 6.

FIG. 8 illustrates another exemplary result according to the method shown in FIG. 6.

FIG. 9 illustrates a flowchart of a peer discovery method according to an embodiment of the disclosure.

FIG. 10 illustrates a block diagram of a peer according to an embodiment of the disclosure.

FIG. 11 is a schematic view of an arrangement which may be used in the peer shown in FIG. 10 according to an embodiment of the disclosure.

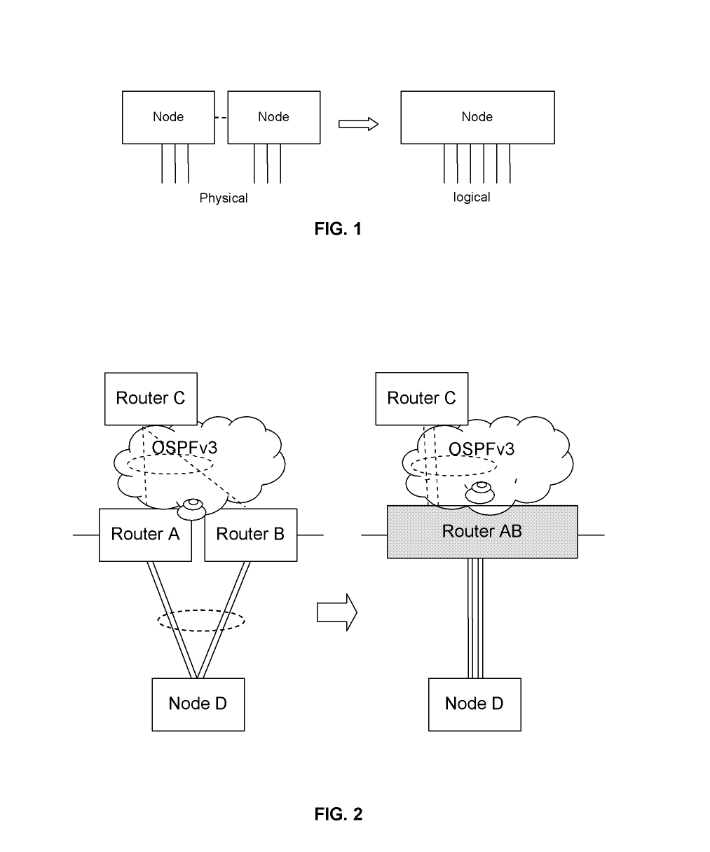

### DETAILED DESCRIPTION OF EMBODIMENTS

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

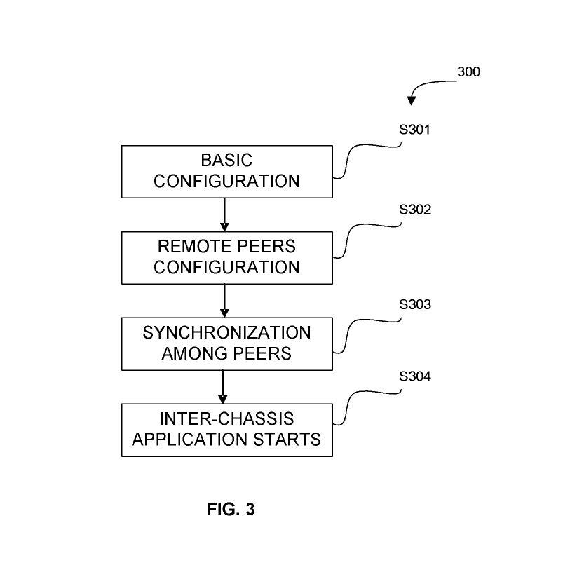

As shown in FIG. 3, in a network comprising an inter-chassis device, the administrator of the network shall perform basic configuration manually by such as, configuring addresses of each system including inter-chassis devices at step S301. Then, the administrator performs remote peer configurations to peers of the inter-chassis device at step S302. Peers of the inter-chassis device subsequently perform synchronization to be synchronous with each other at step S303. Finally, at step S304, the peers may generate and transmit LSAs to perform inter-chassis applications.

LSAs are generated by an inter-chassis device operable under OSPFv3 and propagated through an area to distribute link status. An example of the format of an LSA is defined in RFC 2740, “OSPF for IPv6,” December, 1999, which is incorporated herein by reference, as shown in table I below.

TABLE I
LSA Format

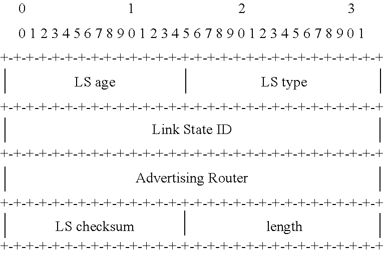

The LSA header contains the LS type, Link State ID and Advertising Router fields. The combination of these three fields uniquely identifies the LSA. In OSPFv3, except network LSAs and link LSAs, Link State ID has no specific limitation and just serves as a way to differentiate multiple LSAs originated from the same router. For network LSAs and link LSAs, Link State ID is equal to the interface ID on the link.

A new Link State ID number planning for peers is proposed according to the disclosure.

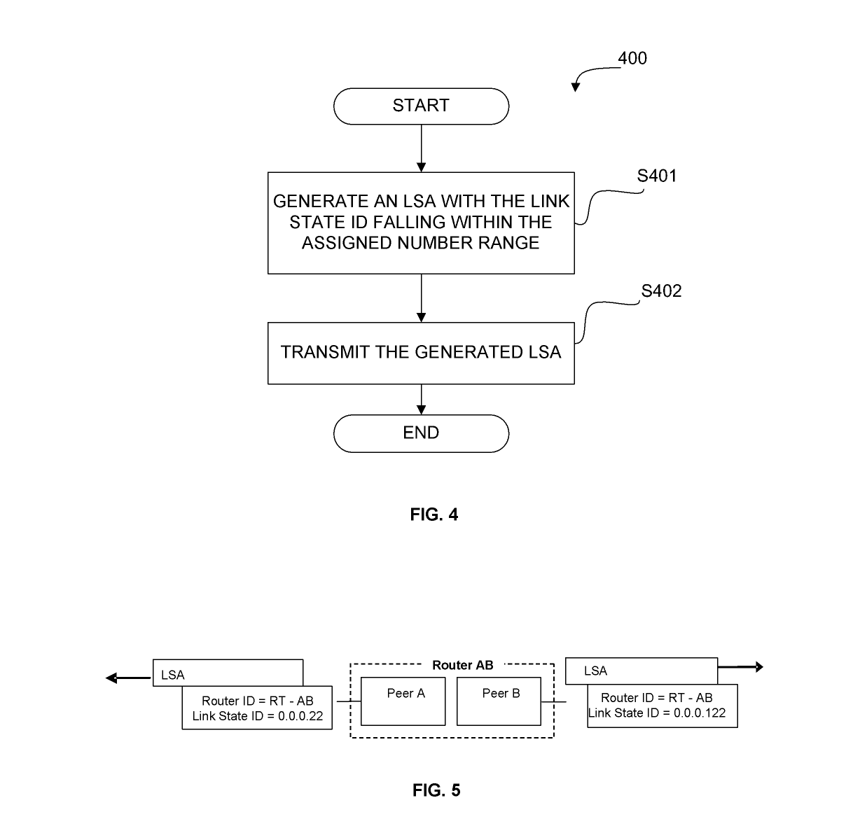

FIG. 4 illustrates a flowchart of a method 400 according to an embodiment of the disclosure. As shown in FIG. 4, the method 400 starts and a peer in the inter-chassis device generates an LSA at step S401, and it transmits the generated LSA outside at step S402. The procedure of the peer generating and transmitting an LSA is compliant with the existing OSPFv3. The difference lies in the Link State ID.

In the method according to an embodiment of the disclosure, the administrator firstly decides a number range to be assigned to each peer in the inter-chassis device. The assignment of the number ranges may depend on the possible numbers of peers in the inter-chassis device. For example, if it is expected that there may be 8 peers in the inter-chassis device, a number range including 30 numerals may be assigned to each peer. In particularly, a peer may be assigned with [0.0.0.1-0.0.0.1.30], another may be assigned with [0.0.0.1.31-0.0.0.1.60]. If a third peer joins in the inter-chassis device later, it may be assigned with [0.0.0.1.61-0.0.0.1.90] or [0.0.0.1.91-0.0.0.1.120] that have not been assigned. The participation of new peers in the inter-chassis device would not need operations or changes on the existing peers in the device. The number range assigned to each peer is different, and does not overlap with each other. The numbers in the number range may be continuous, or discontinuous. For example, take the same 8-peer scenario as an example. A peer may be assigned with [0.0.0.1-0.0.0.10], [0.0.0.21-0.0.0.30] and [0.0.0.41-0.0.0.50] while another peer is assigned with [0.0.0.11-0.0.0.20], [0.0.0.31-0.0.0.40] and [0.0.0.51-0.0.0.60].

FIG. 5 illustrates an exemplary result according to the method shown in FIG. 4. As shown in FIG. 5, Peer A and Peer B constitute an inter-chassis device, i.e., Router AB. Peer A is assigned with the Link State ID number range of [0.0.0.1-0.0.0.100] and Peer B is assigned with the number range of [0.0.0.101-0.0.0.200]. When Peer A in Router AB is to transmit a LSA outside, it selects a number from the Link State ID number range [0.0.0.1-0.0.0.100], and uses the selected number as the Link State ID in the generated LSA, and finally transmits the generated LSA outside. It is also true for Peer B. As an example, an LSA transmitted from Peer A may include Router ID=RT-AB and Link State ID=0.0.0.22, and an LSA transmitted from Peer B may include Router ID=RT-AB and Link State ID=0.0.0.122.

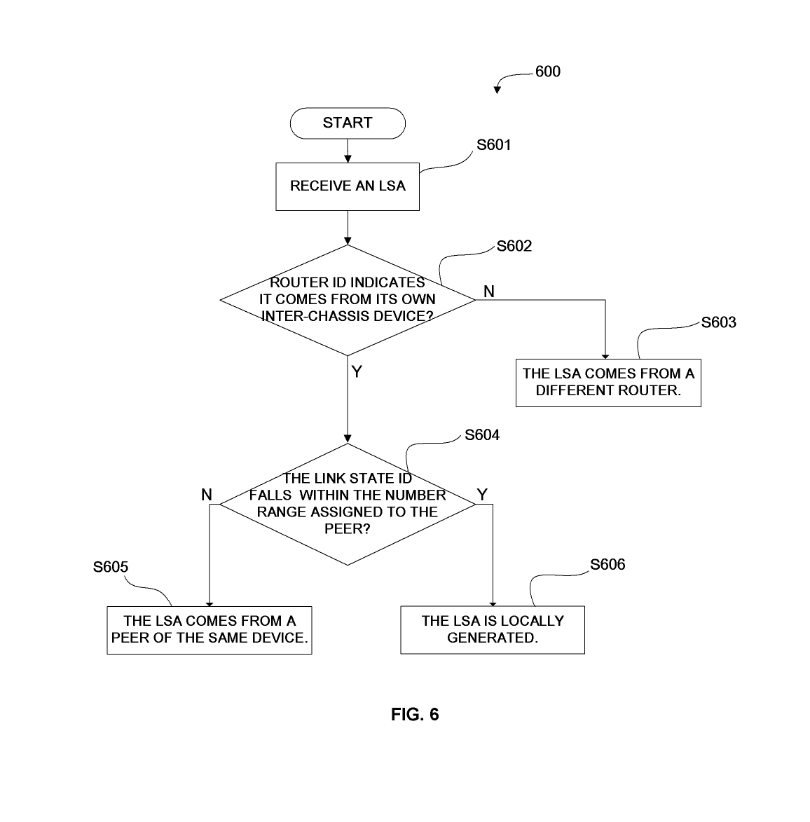

FIG. 6 illustrates a flowchart of a peer discovery method 600 according to an embodiment of the disclosure. The method starts when a peer receives an LSA at step S601. The peer checks Router ID field in the received LSA at step S602. If the Router ID field in the received LSA indicates that it comes from the same inter-chassis device as the peer, it compares the Link State ID in the received LSA with the number range assigned thereto at step S604. It determines that the received LSA is transmitted from another peer in the same inter-chassis device at step S605 if the Link State ID is not in the number range; otherwise, it determines that the LSA is locally generated at step S606. If the Router ID field in the received LSA indicates a different inter-chassis device at step S602, it determines that the LSA comes from a different router at step S603.

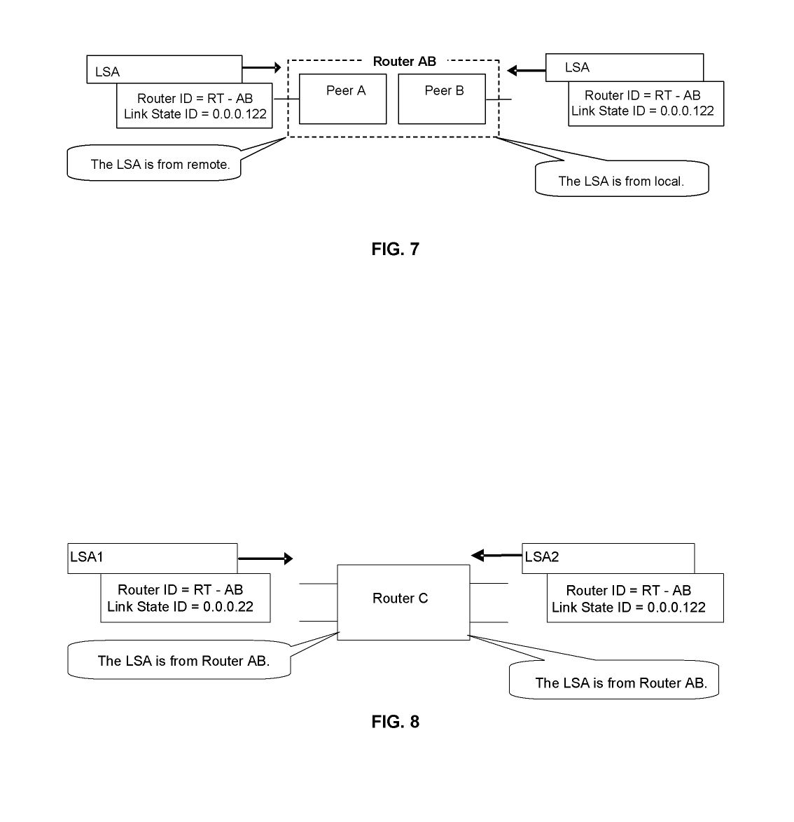

FIG. 7 illustrates an exemplary result according to the method shown in FIG. 6. As shown in FIG. 7, Peer A and Peer B constitute an inter-chassis device, i.e., Router AB. Peer A is assigned with the Link State ID number range of [0.0.0.1-0.0.0.100] and Peer B is assigned with the number range of [0.0.0.101-0.0.0.200]. When Peer A receives an LSA with Link State ID=[0.0.0.122] and Router ID=RT-AB, it determines that the LSA is not generated locally because the Link State ID does not fall in the number range [0.0.0.1-0.0.0.100]. It determines that the LSA comes from another peer in the same inter-chassis device according to Router ID=RT-AB. When Peer B receives an LSA with Link State ID=[0.0.0.122] and Router ID=RT-AB, it determines that the LSA is generated locally because the Link State ID falls in the number range [0.0.0.101-0.0.0.200] and the Router ID field indicates it comes from the same inter-chassis device.

In another example, there are already three peers in one inter-chassis device, i.e., Peer A, Peer B and Peer C, and they are assigned with number ranges of [0.0.0.1-0.0.0.50], [0.0.0.51-0.0.0.100] and [0.0.0.101-0.0.0.150] respectively. The Link State ID number planning is to assign 50 numbers to each peer in the inter-chassis device. If Peer A receives an LSA with a Link State ID=[0.0.0.75] and an LSA with a Link State ID=[0.0.0.125], it knows that they are from two different peers in the same inter-chassis devices. If Peer A receives another LSA with a Link State ID=[0.0.0.175], it knows that another peer joins in the inter-chassis device. Accordingly, a peer may automatically discover other peers by looking into the Link State ID included in the received LSA and the Link State ID number planning in the inter-chassis device.

In the embodiments, after receiving the Link State ID number range assignment, the peer selects a number from the assigned Link State ID number range as the interface ID of the interface. When the peer generates and transmits a network LSA or a link LSA, the Link State ID in the generated LSA will fall within the assigned Link State ID number range. Accordingly, there is no difference for the operation to determine source of a received LSA for a normal LSA (e.g., a Router LSA) and for a network LSA or a link LSA. The method 600 can work.

FIG. 8 illustrates another exemplary result according to the method shown in FIG. 6. As shown, Router C is connected to the inter-chassis device constituted by Peer A and Peer B of FIG. 7. When Router C receives LSA 1 with Link State ID=[0.0.0.122] and Router ID=RT-AB, it determines that the LSA comes from Router AB based on the Router ID field in the received LSA. When Router C receives LSA2 with Link State ID=[0.0.0.122] and Router ID=RT-AB some time later, it determines that the LSA comes from Router AB based on the Router ID field in the received LSA.

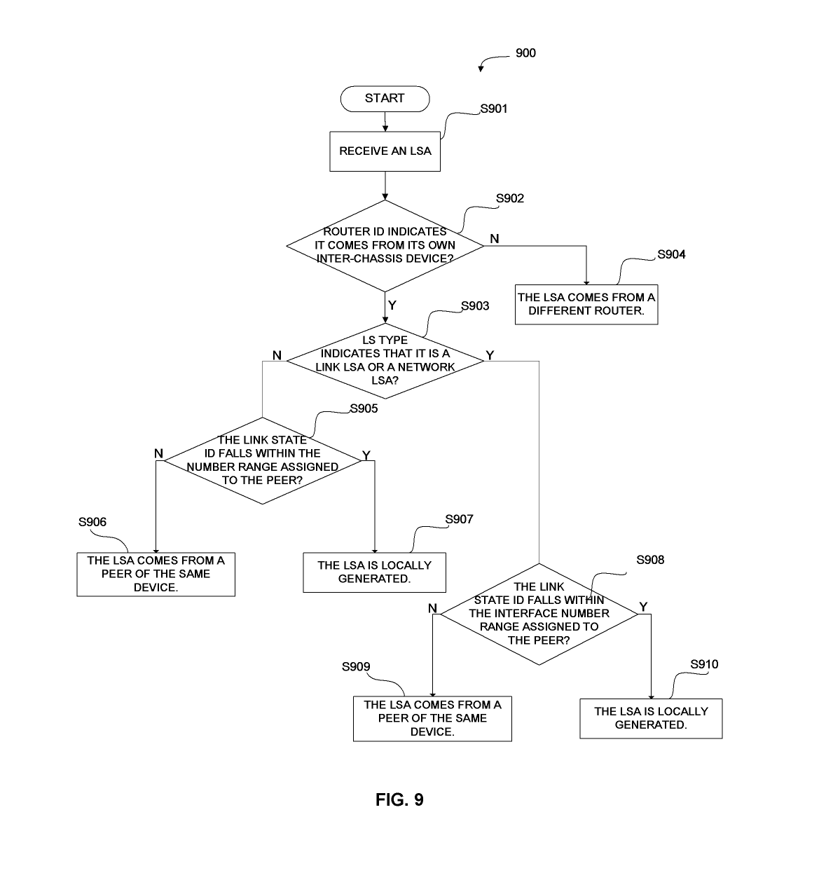

FIG. 9 illustrates a flowchart of a peer discovery method 900 according to another embodiment of the disclosure. The method starts when a peer receives an LSA at step S901. The peer checks Router ID field in the received LSA at step S902. If the Router ID field in the received LSA indicates a different inter-chassis device at step S902, it determined that the LSA comes from a different router at step S904. If the Router ID field in the received LSA indicates that it comes from the same inter-chassis device as the peer, it turns to the LS type field in the received LSA at step S903 to determine the type of the received LSA. If the LS type field in the received LSA indicates the type of the received LSA is link LSA or network LSA at step S903, it compares the Link State ID in the received LSA with the interface number range assigned to the peer at step S908. If the Link State ID in the received LSA falls within the interface number range, it determines that the LSA is locally generated at step S910. Otherwise, it determines that the LSA comes from another peer of the same device at step S909. If it is determined that it is neither a link LSA nor a network LSA at step S903, the peer compares the Link State ID in the received LSA with the Link State ID number range assigned to the peer at step S905. If the Link State ID in the received LSA falls within the Link State ID number range, it determines that the LSA is locally generated at step S907. Otherwise, it determines that the LSA comes from another peer of the same device at step S906.

In the embodiment as shown in FIG. 9, each peer is initially assigned with two number ranges, i.e., a Link State ID number range and an interface number range. The peer selects a number from the interface number range as the interface ID on its interface. The Link State ID number planning and the interface number planning in an inter-chassis device are independent from each other. That is, the Link State ID number ranges assigned to different peers in the inter-chassis device do not overlap with each other, and the interface number ranges assigned to different peers in the inter-chassis device do not overlap with each other. However, the Link State ID number range assigned to one peer does not limit the interface number range assigned to that peer. In other words, for Router AB shown in FIG. 5, Peer A is assigned with the Link State ID number range of [0.0.0.1-0.0.0.100] and Peer B is assigned with the number range of [0.0.0.101-0.0.0.200]. Peer A may be assigned with the interface number range of [0.0.0.101-0.0.0.200] and Peer B may be assigned with the interface number range of [0.0.0.1-0.0.0.100]. Peer A may generate and transmit a Router LSA with Router ID=RT-AB and Link State ID=[0.0.0.22], and generate and transmit a link LSA with Router ID=RT-AB and Link State ID=[0.0.0.122]. Peer B may generate and transmit a Router LSA with Router ID=RT-AB and Link State ID=[0.0.0.122], and generate and transmit a link LSA with Router ID=RT-AB and Link State ID=[0.0.0.22]. When Peer A receives a LSA with Router ID=RT-AB and Link State ID=[0.0.0.122], it firstly determines the type of the received LSA. If it is a router LSA, Peer A determines that it comes from another peer (peer B in the example) in the same inter-chassis device. If it is a link LSA, Peer A determines that it is locally generated (i.e., generated by Peer A itself). By introducing the LS type in determining the source of a received LSA, the number of peers that can be configured in an inter-chassis device is increased.

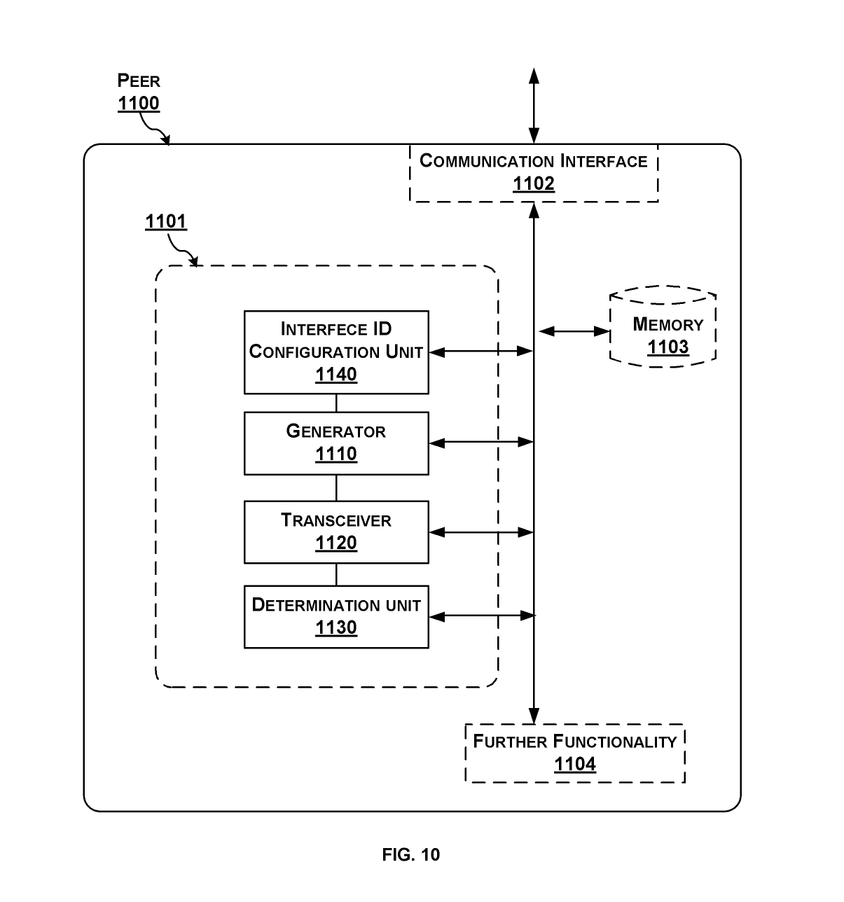

The methods according to the disclosure described above may be performed by any suitable components or other means capable of performing the corresponding functions of the methods. For example, the methods may be performed at any peer of the inter-chassis device, illustrated below in FIG. 10.

FIG. 10 illustrates a block diagram of Peer 1100 according to an embodiment of the disclosure. The part of Peer 1100 which is most affected by the adaptation to the method described herein, e.g., the methods 400, 600 or 900, is illustrated as an arrangement 1101, surrounded by a dashed line. Peer 1100 may be any kind of router, depending on in which type of communication system it is operable. Peer 1100 and arrangement 1101 are further configured to communicate with other entities via a communication interface 1102 which may be regarded as part of the arrangement 1101. The communication interface 1102 comprises means for wireless communication or wired communication with other devices or nodes, such as other peers in the same inter-chassis device or other nodes (such as Node C). The arrangement 1101 or Peer 1100 may further comprise other functional units 1004, such as functional units providing regular router functions, and may further comprise one or more storage units or memories 1103 for storing computer program code and other information thereon. The arrangement 1101 could be implemented, e.g., by one or more of: a processor or a micro processor capable of executing computer program code and adequate software and memory for storing of the software, a Programmable Logic Device (PLD) or other electronic component(s) or processing circuitry configured to perform the actions described above, and illustrated, e.g., in FIG. 4. The arrangement part of Peer 1100 may be implemented and/or described as follows.

As shown in FIG. 10, Peer 1100 comprises a generator 1110 and a transceiver 1120. The generator 1110 is configured to generate an LSA, where the Link State ID in the generated LSA being selected from the Link State ID number range assigned to peer 1110. The transceiver 1120 is configured to transmit the generated LSA. The Link State ID number range assigned to Peer 1100 does not overlap with Link State ID number range assigned to another peer in the inter-chassis device.

According to an embodiment, Peer 1110 may further comprise a determination unit 1130 which is configured to, when Peer 1100 receives an LSA via the transceiver 1120, determine whether the received LSA is transmitted from Peer 1100 by comparing the Link State ID in the received LSA with the Link State ID number range assigned to Peer 1100 if Router ID field in the received LSA indicates that it comes from the same inter-chassis device as Peer 1100.

According to an embodiment, Peer 1100 may further comprise an interface ID configuration unit 1140 which is configured to select a number in an assigned interface number range as an interface ID of an interface of Peer 1100, and wherein the interface number ranges assigned to different peers of the plurality of peers do not overlap with each other. In the embodiment, when Peer 1100 receives a LSA, the determination unit 1130 is configured to determine type of the received LSA based on LS type field in the received LSA if Router ID field in the received LSA indicates that it comes from the same inter-chassis device as the peer. If it is determined that the type of the received LSA is network LSA or link LSA, the determination unit 1130 is configured to determine whether the received LSA is transmitted from Peer 1100 based on a comparison of the Link State ID of the received LSA with the interface number range assigned to Peer 1100. If it is determined that the type of the received LSA is neither network LSA nor link LSA, the determination unit 1130 is configured to determine whether the received LSA is transmitted from Peer 1100 based on a comparison of the Link State ID of the received LSA with the Link State ID number range assigned to Peer 1100.

In the embodiment, if the administrator of the network does not assign interface number ranges to each peer, interface ID configuration unit 1140 in each peer may select a number from the assigned Link State ID number range as the interface ID.

It should be noted that Peer 1100 of FIG. 10 may include more or fewer elements than shown, in various arrangements, and each component may be implemeted in hardware, software or combination thereof.

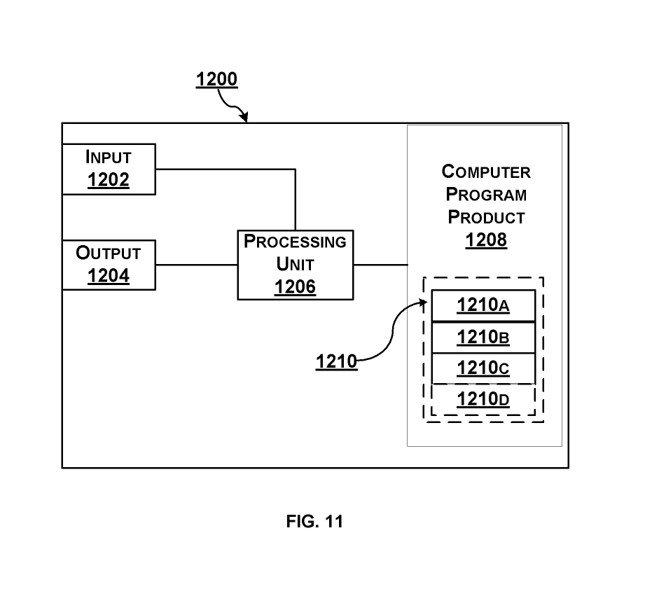

FIG. 11 is a schematic view of arrangement 1200 which may be used in Peer 1100. Comprised in the arrangement 1200 are here a processing unit or processor 1206, e.g., with a Digital Signal Processor (DSP). The processing unit 1206 may be a single unit or a plurality of units to perform different actions of procedures described herein. The arrangement 1200 may also comprise an input unit 1202 for receiving signals from other entities, and an output unit 1204 for providing signal(s) to other entities. The input unit and the output unit may be arranged as an integrated entity or as illustrated in the example of FIG. 10.

Furthermore, the arrangement 1200 comprises at least one computer program product 1208 in the form of a non-volatile or volatile memory, e.g., an Electrically Erasable Programmable Read-Only Memory (EEPROM), a flash memory and a hard drive. The computer program product 1208 comprises a computer program 1210, which comprises code/computer readable instructions, which when executed by the processing unit 1206 in the arrangement 1200 causes the arrangement 1200 and/or Peer 1100 in which it is comprised to perform the actions, e.g., of the procedure described earlier in conjunction with FIG. 4, FIG. 6 or FIG. 9.

The computer program 1210 may be configured as a computer program code structured in computer program modules 1210A-1210D.

In an exemplifying embodiment, the code in the computer program of the arrangement 1200 includes a generation module 1210A for generating an LSA, where the Link State ID in the generated LSA being selected from the Link State ID number range assigned to peer 1110. The code in the computer program 1210 may further include a transceiving module 1210B for transmitting the generated LSA. The Link State ID number range assigned to Peer 1100 does not overlap with Link State ID number range assigned to another peer in the inter-chassis device.

According to an embodiment, the code in the computer program 1210 may further include a determination unit 1210C for, when Peer 1100 receives an LSA via, determining whether the received LSA is transmitted from Peer 1100 by comparing the Link State ID in the received LSA with the Link State ID number range assigned to Peer 1100 if Router ID field in the received LSA indicates that it comes from the same inter-chassis device as Peer 1100.

According to an embodiment, the code in the computer program 1210 may further include an interface ID configuration module 1210D for selecting a number in an assigned interface number range as an interface ID of an interface of Peer 1100, and wherein the interface number ranges assigned to different peers of the plurality of peers do not overlap with each other. In the embodiment, when Peer 1100 receives a LSA, the determination module 1210C determines type of the received LSA based on LS type field in the received LSA if Router ID field in the received LSA indicates that it comes from the same inter-chassis device as the peer. If it is determined that the type of the received LSA is network LSA or link LSA, the determination module 1210C determines whether the received LSA is transmitted from Peer 1100 based on a comparison of the Link State ID of the received LSA with the interface number range assigned to Peer 1100. If it is determined that the type of the received LSA is neither network LSA nor link LSA, the determination module 1210C determines whether the received LSA is transmitted from Peer 1100 based on a comparison of the Link State ID of the received LSA with the Link State ID number range assigned to Peer 1100.

In the embodiment, if the administrator of the network does not assign interface number ranges to each peer, the interface ID configuration module 1210D in each peer may select a number from the assigned Link State ID number range as the interface ID.

According to some embodiments of the disclosure, a peer may automatically discover other peers by the Link State ID contained in a received LSA. Accordingly, there is no need for the administrator to perform remote peer configuration operation. Furthermore, when a new peer joins in the inter-chassis device, other peers in the inter-chassis device remain unchanged. The LSAs generated by different peers do not conflict with each other because the Link State IDs included in the LSAs from different peer falls within different number range. Accordingly, there is no need for the peers to perform synchronization to be synchronous with each other. Furthermore, any of the current routing protocols is applicable in the disclosure, and a network node compliant with an existing routing protocol may cooperate with the peers according to the disclosure well.

The foregoing description of implementations provides illustration and description, but is not intended to be exhaustive or to limit the disclosure to the precise form disclosed. Modifications and variations are possible in light of the above teachings, or may be acquired from practice of the disclosure. For example, while blocks have been described with regard to FIGS. 4, 6 and 9 in a specific order, the order of the blocks may be modified in other implementations consistent with the principles of the disclosure. Further, non-dependent blocks may be performed in parallel.

Aspects of the disclosure may also be implemented in methods and/or computer program products. Accordingly, the disclosure may be embodied in hardware and/or in hardware/software (including firmware, resident software, microcode, etc.). Furthermore, the disclosure may take the form of a computer program product on a computer-usable or computer-readable storage medium having computer-usable or computer-readable program code embodied in the medium for use by or in connection with an instruction execution system. The actual software code or specialized control hardware used to implement embodiments described herein is not limiting of the disclosure. Thus, the operation and behaviour of the aspects were described without reference to the specific software code—it being understood that those skilled in the art will be able to design software and control hardware to implement the aspects based on the description herein.

Furthermore, certain portions of the disclosure may be implemented as “logic” that performs one or more functions. This logic may include hardware, such as an application specific integrated circuit or field programmable gate array or a combination of hardware and software.

It should be emphasized that the term “comprises/comprising” when used in this specification is taken to specify the presence of stated features, integers, steps, components or groups but does not preclude the presence or addition of one or more other features, integers, steps, components or groups thereof.

No element, act, or instruction used in the disclosure should be construed as critical or essential to the disclosure unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

The foregoing description gives only the embodiments of the present disclosure and is not intended to limit the present disclosure in any way. Thus, any modification, substitution, improvement or like made within the spirit and principle of the present disclosure should be encompassed by the scope of the present disclosure.

1. A method used in a peer in an inter-chassis device comprising a plurality of peers, comprising:
generating a Link State Advertisement (LSA), the generated LSA having a Link State ID selected from a Link State ID number range assigned to said peer, wherein the Link State ID number ranges assigned to different peers of the plurality of peers do not overlap with each other; and
transmitting the generated LSA.

2. The method according to claim 1, further comprising:
receiving an LSA; and
determining whether the received LSA is transmitted from said peer based on a comparison of the Link State ID in the received LSA with the Link State ID number range assigned to said peer if Router ID field in the received LSA indicates that it comes from the same inter-chassis device as the peer.

3. The method according to claim 1, further comprising:
selecting a number in an assigned interface number range as an interface ID of an interface of said peer, wherein the interface number ranges assigned to different peers of the plurality of peers do not overlap with each other.

4. The method according to claim 3, further comprising:
receiving an LSA;
determining type of the received LSA based on LS type field in the received LSA if Router ID field in the received LSA indicates that it comes from the same inter-chassis device as the peer; and
determining whether the received LSA is transmitted from said peer based on a comparison of the Link State ID of the received LSA with the interface number range assigned to said peer if it is determined that the type of the received LSA is network LSA or link LSA.

5. The method according to claim 3, further comprising:
receiving an LSA;
determining type of the received LSA based on LS type field in the received LSA if Router ID field in the received LSA indicates that it comes from the same inter-chassis device as the peer; and
determining whether the received LSA is transmitted from said peer based on a comparison of the Link State ID of the received LSA with the Link State ID number range assigned to said peer if it is determined that the type of the received LSA is neither network LSA nor link LSA.

6. The method according to claim 1, wherein the inter-chassis device is a router operable under Open Shortest Path First (OSPF) for Internet Protocol version 6 (IPv6).

7. A peer in an inter-chassis device comprising a plurality of peers, comprising:
a generator configured to generate a Link State Advertisement (LSA), the generated LSA having a Link State ID selected from a Link State ID number range assigned to said peer, wherein the Link State ID number ranges assigned to different peers of the plurality of peers do not overlap with each other; and
a transceiver configured to transmit the generated LSA.

8. The peer according to claim 7, wherein the peer further comprises a determination unit configured to:
when said peer receives an LSA via the transceiver, determine whether the received LSA is transmitted from said peer by comparing the Link State ID in the received LSA with the Link State ID number range assigned to said peer if Router ID field in the received LSA indicates that it comes from the same inter-chassis device as the peer.

9. The peer according to claim 7, wherein the peer further comprises an interface ID configuration unit configured to select a number in an assigned interface number range as an interface ID of an interface of said peer, and wherein the interface number ranges assigned to different peers of the plurality of peers do not overlap with each other.

10. The peer according to claim 9, wherein the peer further comprises a determination unit configured to determine type of a received LSA based on LS type field in the received LSA if Router ID field in the received LSA indicates that it comes from the same inter-chassis device as the peer.

11. The peer according to claim 10, wherein the determination unit is further configured to
determine whether the received LSA is transmitted from said peer based on a comparison of the Link State ID of the received LSA with the interface number range assigned to said peer if it is determined that the type of the received LSA is network LSA or link LSA; and
determine whether the received LSA is transmitted from said peer based on a comparison of the Link State ID of the received LSA with the Link State ID number range assigned to said peer if it is determined that the type of the received LSA is neither network LSA nor link LSA.

12. The peer according to claim 7,
wherein the inter-chassis device is a router operable under Open Shortest Path First (OSPF) for Internet Protocol version 6 (IPv6).

13. A peer in an inter-chassis device comprising a plurality of peers, comprising:
at least one communication interface arranged for communication,
a processor; and
a memory storing computer program code thereon which, when run in the processor, causes the peer to:
select a number from a Link State ID number range assigned to said peer; and
generate a Link State Advertisement (LSA) by using the selected number as a Link State ID, wherein the Link State ID number ranges assigned to different peers of the plurality of peers do not overlap with each other.

14. The peer according to claim 13, wherein when it receives an LSA via the communication interface, the peer is further caused to:
compare the Link State ID in the received LSA with the Link State ID number range assigned to said peer if Router ID field in the received LSA indicates that it comes from the same inter-chassis device as the peer, and determine that the received LSA is transmitted from another peer in the same inter-chassis device if the Link State ID of the received LSA is not in the Link state ID number range.

15. The peer according to claim 13, wherein the peer is further caused to select a number in an assigned interface number range as an interface ID of an interface of said peer, and wherein the interface number ranges assigned to different peers of the plurality of peers do not overlap with each other.

16. The peer according to claim 15, wherein when it receives an LSA via the communication interface, the peer is further caused to:
determine type of the received LSA based on LS type field in the received LSA, and
determine whether the received LSA is transmitted from said peer based on a comparison of the Link State ID of the received LSA with the interface number range assigned to said peer if it is determined that the type of the received LSA is network LSA or link LSA.

17. The peer according to claim 15, wherein when it receives an LSA via the communication interface, the peer is further caused to:
determine type of the received LSA based on LS type field in the received LSA, and
determine whether the received LSA is transmitted from said peer based on a comparison of the Link State ID of the received LSA with the Link State ID number range assigned to said peer if it is determined that the type of the received LSA is neither network LSA nor link LSA.

18. The peer according to claim 13, wherein the inter-chassis device is a router operable under Open Shortest Path First (OSPF) for Internet Protocol version 6 (IPv6).
